(19) United States
(12) Patent Application Publication
(10) Pub. No.: US 2005/0095985 A1
(43) Pub. Date: May 5, 2005

(54) Method and apparatus for multi-user interference determination an rejection

(76) Inventor: Abdulrauf Hafeoz, Morrisville, NC (US)

Correspondence Address: COATS & BENNETT, PLLC, P O BOX 5, RALEIGH, NC, 27602, US

(21) Appl. No.: 10/698,206

(22) Filed: Oct. 31, 2003

(51) Int. Cl. H04B 17/00

(52) U.S. Cl. 455/67.11

(57) ABSTRACT

A receiver circuit identifies one or more interfering signals received with a desired signal by generating and evaluating one or more hypothesized interferers. By testing these hypotheses, such as through joint synchronization and channel estimation for the desired signal and the one or more hypothesized interferers, the circuit identifies which hypothesized interferer(s) best correspond to the dominant interfering signal(s) actually received. Channel models thus obtained for the dominant interferer(s) may be used in, for example, generating a whitening filter used in interference suppression, or jointly demodulating the desired and interfering signal(s).

### BACKGROUND OF THE INVENTION

The present invention generally relates to wireless communication receivers, and particularly relates to a wireless communication receiver that uses hypothesis testing to detect and suppress interference.

Wireless communication receivers often operate under challenging reception conditions. For example, over-the-air transmission of radio signals results in some degree of signal corruption. These problems further are complicated by, for example, multipath propagation, and dynamically varying fading and interference conditions. In a common approach to improving reception performance, a receiver estimates channel conditions based on “training information” in the received signal (or signals) that is known a priori by the receiver. The receiver can use the channel estimates to compensate actively unknown data in the desired signal to remove (or at least reduce) propagation channel effects and thereby improve its reception performance.

In a wireless communication network that supports a plurality of users, the network may transmit many signals to support the ongoing communications of the active users. Thus, a given user's wireless receiver typically receives its desired signal(s) along with one or more undesired signals intended for other users operating in the same or a nearby service area. Those signals intended for the other users thus represent potentially interfering signals that can degrade the receiver's ability to recover information from the desired signal at acceptable levels of accuracy.

### SUMMARY OF THE INVENTION

The present invention comprises a method and apparatus for interference suppression in a wireless communication receiver. In one or more exemplary embodiments, a receiver circuit, such as may be included in a mobile terminal, receives desired and interfering signals, generates one or more interference hypotheses for the interfering signals based on combinations of known signal sequences and relative signal delays, and tests the one or more interference hypotheses to identify one or more dominant interferers from among the interfering signals. Testing may comprise jointly estimating channel models for the desired signal and the one or more hypothesized interferers, and identifying the one or more dominant interferers by determining which hypothesized interferers yield the desired, e.g., the best, channel models. The channel models thus obtained for the hypothesized interferers may be used to generate a whitening filter to suppress the interferers, or for joint demodulation of the desired signal and the interferers. Such processing may be performed on a per timeslot basis, where the receiver receives desired and interfering signals in each of one or more communication timeslots.

Where the dominant interferer is a signal type not suited to whitening filter suppression, but where the desired signal is, the desired signal may be suppressed to recover the interferer. The reconstructed interferer may then be canceled for recovery of the desired signal. Thus, an exemplary method of suppressing interference in a wireless communication receiver comprises buffering a composite received signal comprising combined desired and interfering signals, generating an estimated interfering signal by suppressing the desired signal in the composite received signal, and recovering the desired signal from the composite received signal by canceling the estimated interfering signal from the composite received signal.

Generating the whitening filter to suppress the desired signal may comprise reconstructing the desired signal over a desired signal training period using a known training sequence and desired signal channel estimates, and estimating the whitening filter based on the reconstructed desired signal. With these operations, suppressing the desired signal and recovering the interferer may comprise obtaining a filtered signal by applying a whitening filter to the composite received signal, wherein the whitening filter is configured to suppress the desired signal, reconstructing the interferer by detecting interfering data symbols in the filtered signal, and then canceling the reconstructed interferer from the composite signal.

### BRIEF DESCRIPTION OF THE DRAWINGS

FIGS. 1A and 1B are diagrams of an exemplary wireless receiver according to one or more embodiments of the present invention.

FIG. 2 is a diagram of typical TDMA frame and slot formats.

FIG. 3 is a diagram of exemplary processing logic according to one or more embodiments of the present invention.

FIG. 4 is a diagram of exemplary processing logic according to one or more embodiments of the present invention for a two-signal example.

FIG. 5 is a diagram of relative desired and interfering signal timing for a given interference example.

FIGS. 6 and 7 are diagrams of exemplary processing logic for two scenarios of interference suppression through successive cancellation.

FIG. 8 is a diagram of an exemplary mobile terminal in which the present invention may be embodied.

FIG. 9 is a diagram of an exemplary wireless communication network in which the present invention may be embodied.

### DETAILED DESCRIPTION OF THE INVENTION

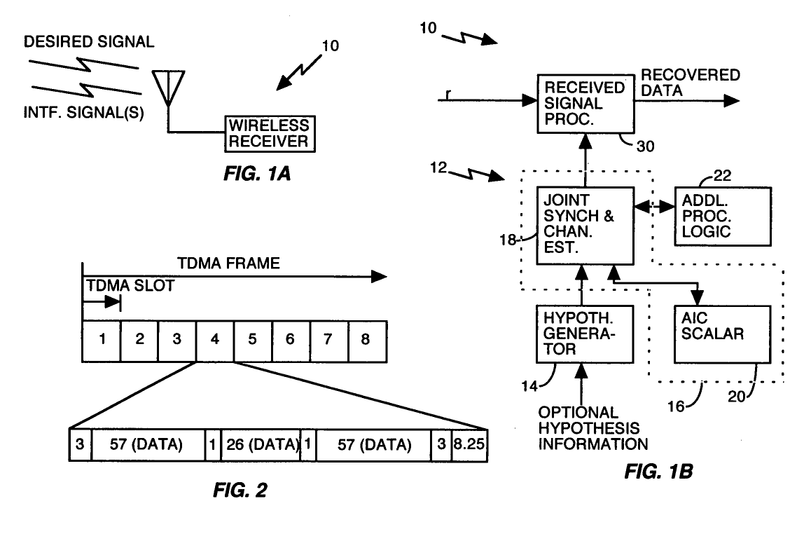

FIG. 1A presents a simplified illustration of a wireless communication receiver 10, which may operate in a Time Division Multiple Access (TDMA) based wireless communication network, such as IS-136, GSM, or GSM/EDGE communication networks, wherein it receives desired and interfering signals in each of one or more assigned communication timeslots. According to one or more exemplary embodiments of the present invention, receiver 10 combats interference by identifying “on-the-fly” the dominant interfering signals in each of one or more communication timeslots based on hypothesizing one or more “interferers,” and testing those hypotheses to determine which one(s) best correspond to the actual interference experienced in each timeslot. Identification of the dominant interferers allows receiver 10, for example, to suppress interference in the received signal.

FIG. 1B illustrates an exemplary receiver circuit 12 for use in receiver 10 to support the above functionality. It should be understood that the illustrated circuit 12 presents an exemplary functional arrangement that may or may not correspond to a literal implementation of signal processing circuitry. For example, one or more of the illustrated functional circuit elements may be implemented as part of other signal processing elements in receiver 10. Regardless, the exemplary circuit 12 comprises a hypothesis generator 14, an evaluation circuit 16, including a joint synchronization and channel estimation circuit (joint processor) 18 and an optional scaling processor 20, and may comprise further processing logic 22. The additional processing logic 22 may comprise added signal processing circuits, for example, to suppress interference in the desired signal, such as by generating a “whitening” filter.

Given its broad range of applications and the variety of systems in which the present invention may be implemented, those skilled in the art should appreciate that the present invention may be embodied in any number of specific physical implementations, including but not limited to the exemplary embodiment illustrated in FIG. 1B. For example, the processing associated with hypothesizing and testing interferers, and with using interferer channel models obtained from that processing in interference suppression, may be supported by dedicated hardware, or implemented in software, or implemented as some combination of the two. More generally, the present invention may be embodied in hardware and/or software (including firmware, resident software, micro-code, etc.). Furthermore, the present invention may take the form of a computer program product on a computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

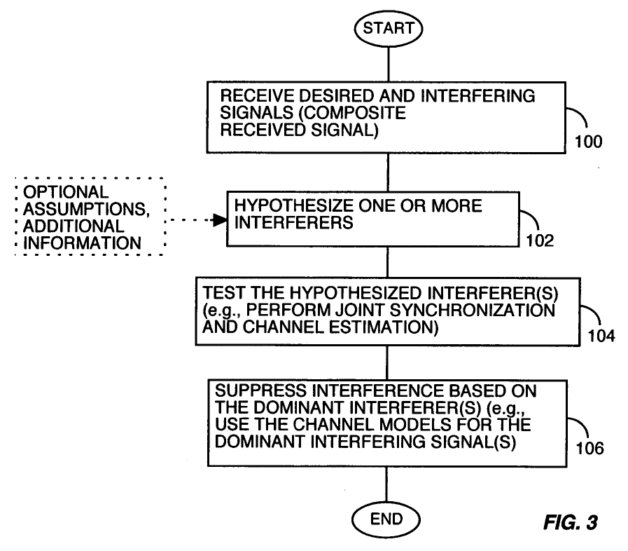

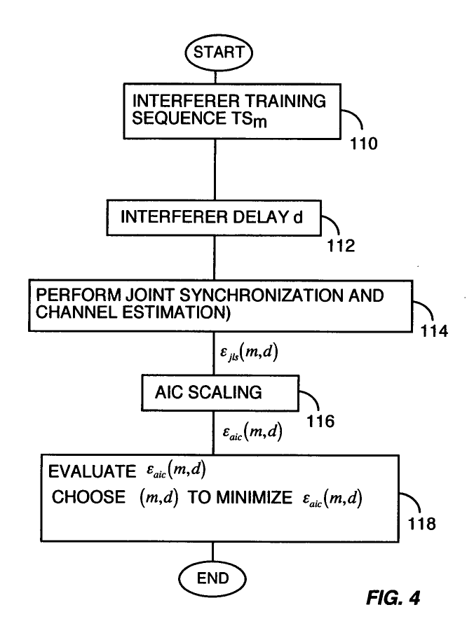

FIG. 2 illustrates exemplary TDMA frame and slot formats, such as might be used in GSM-based networks. A frame comprises a plurality of defined timeslots, wherein each slot may be used as a logical channel assigned to a given user. Thus, by synchronizing their reception to assigned timeslots, each of a plurality of users receives a desired information signal in each frame. Commonly, the information signal transmitted in each slot carries individual user data as well as overhead data, including starting and ending header bytes and some type of training data. The illustrated timeslot arrangement corresponds to GSM standards, however it should be understood that this is a non-limiting example. Here, the middle 26 bytes comprise a training sequence known to receiver 10, such that receiver 10 can generate an updated radio channel model for the desired signal in each timeslot. Placing the training sequence in the middle of the slot minimizes the maximum slot distance—time—between the training sequence and the first or last bytes of transmitted data, which is advantageous in terms of limiting channel estimation inaccuracies arising from changes in received signal fading over the slot time.

In a given radio service area, each user (active mobile terminal) typically is assigned one or more timeslots in each TDMA frame. With this arrangement, each downlink frequency channel in a first service area carries multiplexed communications for a plurality of users operating on that frequency. Other users in the same service area typically operate in like multiplexed fashion but on other frequency channels. With frequency reuse, still other users in surrounding service areas operate on the same frequency channels as used in the first service area.

The desired signal for a given user is subject to various sources of interference, including co-channel and adjacent channel interference. With co-channel interference, same-frequency signals for users in other service areas interfere with the desired signal. With adjacent channel interference, different frequency signals of other users in the same or neighboring service areas interfere with the desired signal. Note that adjacent channels may be relatively close in frequency, e.g., spaced apart by the default 200 KHz channel offsets used in GSM. Receiver circuit 12 may be configured for either or both adjacent and co-channel interference detection and suppression.

In operation, for each given timeslot, receiver 10 receives its desired signal, i.e., the signal intended for it in that timeslot, and further receives one or more interfering signals associated with other users. In an exemplary embodiment, all received signals (desired and interfering) each include a known training sequence. For example, GSM networks typically use a set of eight possible training sequences. Thus, receiver 10 may or may not know the particular training sequences included in the interfering signals received in any given communication timeslot, but it at least knows the universe of possible choices for those training sequences. As such, receiver circuit 12 may be used to detect and suppress one or more interfering signals in each timeslot by hypothesizing which interfering training sequences were received at what relative signals delays. With this approach, the receiver circuit 12 generates hypothesized interferers, for example, as combinations of possible training sequences and relative signal delays.

FIG. 3 broadly illustrates an exemplary signal-processing configuration for receiver circuit 12. Processing for a given timeslot begins with receipt of desired and interfering signals (Step 100). To dynamically cancel the dominant interfering signals in the timeslot, without need for presupposing the training sequences or timing alignments/offsets associated with the interfering signals present in the timeslot, receiver circuit 12 generates one or more interference hypotheses (Step 102). In this context, circuit 12 generates one or more hypothesized interferers to represent the actual interference, wherein a hypothesized interferer comprises a selected one of the possible training sequences positioned at a given delay relative to the desired signal. In some embodiments, the hypothesized interferers further include hypothesized frequency offsets, etc.

In any case, receiver circuit 12 determines which one(s) of the hypothesized interferers best corresponds to the actual interference by testing the hypotheses (Step 104). In an exemplary embodiment, receiver circuit 12 tests the hypotheses by performing joint synchronization and channel estimation between the desired signal and the hypothesized interferers. With this approach, circuit 12 jointly determines radio channel models for the desired signal and one or more of the hypothesized interferer(s). Because the training sequence of the desired signal is known, the desired signal's channel model may be “assessed” in terms of its accuracy. Thus, circuit 12 can identify the hypothesized interferers most closely representative of the actual dominant interference by determining which hypothesized interferers yield the best jointly determined channel model for the received signal.

In one or more exemplary embodiments, the above process offers advantages in that the disclosed joint processing generates channel models for the hypothesized interferers as well as for the desired signal. Therefore, identifying the “best” hypothesized interferer(s) amount to identifying the channel model(s) most accurately representing the dominant actual interference. These jointly determined interferer channel models can be used advantageously by circuit 12 in suppressing interference by, for example, generating a whitening filter based on the interferer channel models (Step 106). The co-pending and commonly assigned patent application identified by Attorney Docket No. 8194-719/P16957-US1-PUCP and entitled, “APPARATUS AND METHOD FOR SUPRESSION OF INTERFERENCE AMONG DISPARATELY MODULATED SIGNALS,” provides a discussion regarding the generation and use of whitening filters and is incorporated herein by reference.

Note that in the above processing, hypothesizing efficiency may be gained by reducing the search space over which interferer hypotheses are generated. For example, receiver circuit 12 may receive, or otherwise have access to, information identifying a reduced set of specific training sequences for which it should generate hypotheses. Where other modulation formats are considered, or where adjacent channel interference is considered, circuit 12 may receive information that allows it to narrow the number of combinations used in generating the hypothesized interferers.

In describing an exemplary embodiment of the present invention in further detail, it should be noted that the present invention provides one or more methods for estimating the radio channel responses and relative signal delays (e.g., channel taps and symbol timings) for the desired signal and the interfering signals present in each slot. In a given timeslot, receiver 10 receives at least partially overlapping training sequences for the desired signal and for one or more interfering signals. With its a priori knowledge of the interfering training sequences that could be present in each slot, circuit 12 can detect interference in each slot by detecting the presence of known training sequences.

As noted in the above discussion regarding FIG. 3, an exemplary embodiment of the present invention uses joint synchronization and channel estimation of the channel response of the desired signal and the interfering signals, wherein the training sequences and symbol timings of the dominant interfering signals are detected by hypothesis testing.

For clarity of discussion, FIG. 4 illustrates detailed processing for two users (i.e., a desired signal for a first user and an interfering signal for a second user). That is, FIG. 4 illustrates exemplary processing for one interfering signal. It should be understood that the exemplary method may be extended to any number of interfering signals as needed or desired.

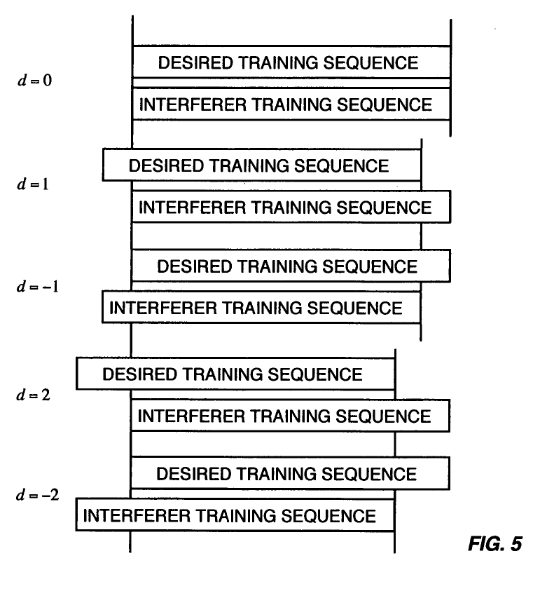

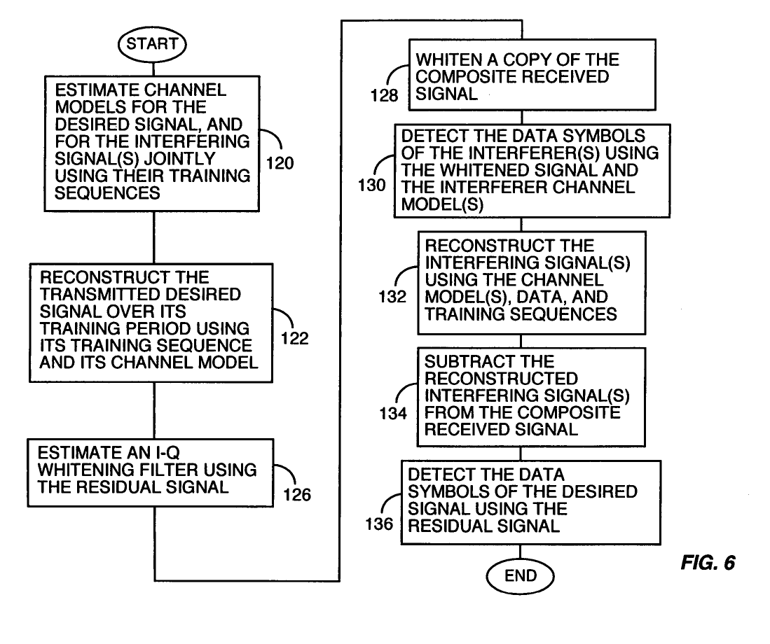

For one interfering signal, interferer, circuit 12 generates hypothesized interferers by assuming that one or more known training sequences were received in conjunction with the training sequence of the desired signal. FIG. 5 illustrates hypothesized interferers based on assuming that a given training sequence (TS) was received at varying relative delays, i.e., delay (d)=0, 1, −2, 2, and −2. Delay units may be chosen based on various unit timings as whole numbers of fractional numbers.

Here, delays are selected based on defined symbol times. Thus, the depicted hypothesized interferers represent a known training sequence m assumed to be received as an interfering signal at relative symbol delays d of −2, −1, 0, 1, and 2. It should be understood that a like number of hypothesized interferers may be generated at the same delays for other known training sequences. Further, it should be understood that the combinations of variables, here sequence and delay, may be expanded to include modulation format, channel frequency offset, etc., with attendant increases in the number of hypothetical interferer combinations.

For example, where circuit 12 hypothesizes that an interfering signal is an adjacent channel signal, that signal can be viewed like a co-channel (same frequency signal) but with a rotation rate given by,

$$ω = 2 π \frac{Δ f}{{f}_{s}} , \qquad ( 1 )$$

where ω is in radians, and where Δf is the carrier frequency offset of the adjacent channel signal with respect to the desired signal and fₛ is the sampling frequency. Thus, an adjacent channel interfering signal can be detected by circuit 12 as if it were a co-channel interfering signal by applying a modulation rotation to it. Similarly, circuit 12 can detect interfering signals having modulation formats different from that of the desired signal by applying a similar modulation rotation, and such rotations may be combined for detection of adjacent channel signals having differing modulation formats.

The various rotations, e.g., defined values for known channel frequency offsets, known modulation format differences, etc., all can be made part of the hypotheses interferer search space. Of course, the range of hypothetical combinations can be limited by limiting the possible rotations to the closest adjacent channels and/or by limiting them to the one or two most probable modulation formats, e.g., to GMSK and 8PSK for GSM/EDGE systems.

Returning to FIG. 4, hypothesis testing begins by selecting a particular training sequence m taken at a particular relative delay d to form a hypothesized interferer to be evaluated (Steps 110 and 112). For the selected m and d, joint processor 18 performs joint channel synchronization and estimation, wherein the symbol timing for the desired signal, δ₀, is given by minimizing the least squares error given by,

$${ɛ}_{ls} = {\sum }_{n = δ}^{{N}_{T} - δ - 1} {\vert {y}_{n} - {\hat{y}}_{n} \vert}^{2} , \qquad ( 2 )$$

over a given range of hypothesized timings δ, where N_{T} is the training period, yₙ is the received signal and ŷₙ is the estimated received signal obtained by summing the reconstructed signals of the desired and interfering signals using the training symbols and channel estimates.

The least-squares error for the chosen desired signal timing, εₗₛ(m, d), can be used to select the “best” hypothesized interferer sequence and delay (i.e., to select the hypothesized training sequence and relative delay that most closely corresponds to the actual interfering signal). Note that the number of symbols used for training (or the training period N_{T}) decreases as |d| increases because of reduced desired-to-interferer training sequence overlap, which may make channel estimates for greater relative delays somewhat “noisier.”

Improved comparisons over the range of hypothesized delays may be obtained by scaling the least-squares error according to, for example, the Akaike Information Criterion (AIC), which operation may be provided by the optional scaling processor 20 illustrated in FIG. 1B. Joint processor 18 provides least-squares error values, εₗₛ(m, d), to scaling processor 20, which implements the following expression,

$${ɛ}_{aic} ( m , d ) = \frac{{ɛ}_{ls} ( m , d )}{{N}_{T} - 2 \vert d \vert - L + 1} exp ( \frac{{K}_{aic} * L}{{N}_{T} - 2 \vert d \vert - L + 1} ) , \qquad ( 3 )$$

where L is the number of channel taps to be estimated for each signal and K_{aic} is an arbitrary scaler constant. The interferer sequence m₀ and delay d₀ that minimize the AIC-scaled error, ε_{aic}(m, d), are chosen along with the corresponding jointly determined desired user timing and desired and interfering channel estimates.

As noted, the above joint synchronization and channel estimation may be generalized to detect multiple interfering signals but at the expense of additional processing requirements. For example, to detect two interferers in GSM/EDGE systems with their use of eight defined training sequences, circuit 12 may generate and test up to 7×6=42 hypotheses, based on there being up to seven possible training sequences shifted at relative delays up to three symbol periods on either side of the desired signal training sequence.

Thus, circuit 12 may narrow its hypothetical search space by one or more pre-processing operations. For example, circuit 12 may perform individual synchronization and channel estimation for each possible training sequence to pick a reduced set of sequences and delays that minimize the least-squares error (or maximize a correlator output). In other words, by testing possible sequences on an individual basis, circuit 12 may identify which possible training sequences are most likely actually present as interfering signals, and then perform joint synchronization and channel estimation using that reduced set of possibilities. Further, a supporting network may assist circuit 12 in reducing its search space by, for example, providing it with information regarding the training sequences actually being used by the network for other receivers in the same and/or in surrounding service areas (cells).

Because performance improvements may be compromised with over-estimating the number of interfering signals, it may be desirable to detect only a defined number of interferers in each timeslot, e.g., only the dominant interfering signals. The number of dominant interfering signals actually present in a timeslot (up to a detection count maximum) may be detected by comparing the least-squares errors for the various numbers of interferers, after scaling them to account for the differing hypothesized delays, e.g., after performing AIC scaling. The number of channel taps for the interferers also can be determined adaptively.

The information obtained in the above joint processing and testing may be used in a number of ways, such as to suppress interference. In an exemplary embodiment of the present invention, coherent joint demodulation of the desired and interfering signals' data symbols is used to explicitly cancel the interference. For example, the additional processing logic 22 and/or signal processing circuitry 30 illustrated in FIG. 1 may use the channel estimates obtained for the desired and at least the dominant interfering signal(s) to cancel the interfering signal(s) through joint demodulation.

Joint processing and testing as outlined above generates channel model estimates for the desired signal and the hypothesized interferers, and identifies the hypothesized interferers that best represent actual interference. The channel models of those estimates thus serve as accurate channel estimates for obtaining the whitening filter taps for interference suppression.

In some instances, an interfering signal may be of a type not suited to suppression via whitening filter. For example, an 8PSK interferer represents a two-parameter (phase and amplitude) modulation format not suitable for direct suppression through spatial-temporal whitening. Thus, an exemplary embodiment of the present invention provides interference suppression based on a successive cancellation method that suppresses the desired signal via use of a whitening filter to recover a more accurate reconstruction of the interferer. The reconstructed interferer may then be canceled from the received signal, which is a composite of the desired and interfering signal, for improved recovery of data in the desired signal.

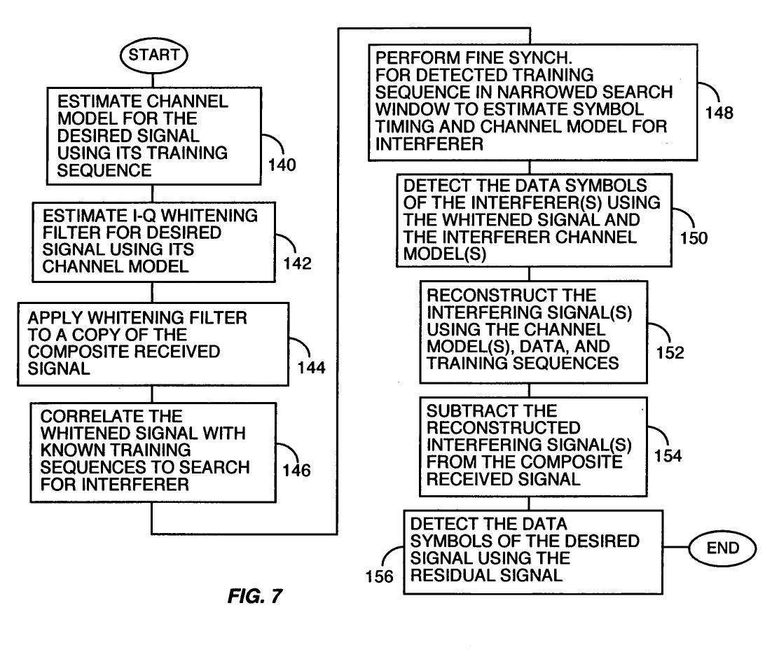

FIGS. 6 and 7 illustrate exemplary successive cancellation methods according to the present invention. The processing logic of FIG. 6 assumes at least quasi-synchronous desired and interfering signals wherein there is at least a few symbols of overlap between the desired and interfering signals' training sequences.

An exemplary wireless receiver generates composite received signal samples, where each of the buffered samples comprises a combination of desired and interfering signals. Processing begins with an estimation of the channel models for the desired signal, which may be a GMSK signal, and the interfering signal, which may be an 8PSK signal (Step 120). Such channel model estimation may be based on the exemplary joint synchronization and estimation described above.

The desired signal is reconstructed over the training sequence period based on the known training sequence and estimated channel model (Step 122). The reconstructed desired signal is then used to generate the whitening filter (Step 126). The whitening filter is a spatial-temporal whitening filter. In the case of a single receive antenna, the In-phase and Quadrature (I-Q) received samples correspond to the spatial component of the whitening filter. Thus, for the case of a single receive antenna, the whitening filter may be referred to as an I-Q whitening filter.

After whitening the received composite signal (Step 128), e.g., by applying the whitening filter to a copy of the received composite signal samples to suppress the desired signal components in the composite signal samples, the exemplary receiver then detects the data symbols of the interferer using the whitened (filtered) samples and the interferer's channel model (Step 130). It then reconstructs the interfering signal using the channel model, the recovered data symbols, and the interferer's training symbols (Step 132).

With the interferer thus recovered, recovery of data in the desired signal may be improved by canceling the reconstructed interferer from the composite received signal samples. In one or more embodiments, such cancellation is based on subtracting the recovered interferer from the composite received signal. (Step 134). With the interfering signal thus canceled, the desired signal's data symbols are detected.

It may be that the interfering signal essentially is asynchronous relative to the desired signal, at least within the time window under consideration, i.e., there may be little or no overlap between the desired and interfering signals' training sequences. In this instance, the previously described joint synchronization and channel estimation cannot be used to jointly generate desired and interfering signal channel models. However, FIG. 7 illustrates a variation of the processing logic disclosed in FIG. 6 that complements the asynchronous interferer scenario.

Processing begins with estimation of the channel model for the desired signal using, for example, its known training sequence (Step 140). An I-Q whitening filter is then generated from the desired signal's channel model (Step 142), and the whitening filter is applied to the composite received signal to suppress the desired signal (Step 144). Correlating the resulting whitened (filtered) signal with one or more known training sequences to search for the interferer signal (Step 146). Where the number of possible training sequences is limited to a defined set—GSM networks use eight defined training sequences, for example—searching for the interferer may comprise identifying the training sequence that yields the maximum correlation response with the whitened signal. The search space may be reduced by eliminating the desired signal's training sequence from the search space set, and may be further reduced by receiving from the network the training sequence (or sequences) being used by the network in the receiver's current service area.

After identifying the interfering signal's training sequence, fine synchronization with the detected training sequence in a reduced time window enables estimation of the symbol timing and the channel model for the interfering signal (Step 148). Of course, the present invention is not limited to detecting the interfering signal according to these steps. For example, one or more blind detection methods may be used to detect the interfering signal.

Once the interfering signal's timing and channel model are obtained, or it is otherwise characterized in a manner that enables detection of its data symbols in the whitened signal (Step 150), the interfering signal is reconstructed using its detected data symbols, its training sequence, and its channel model (Step 152). The reconstructed interferer is then canceled, e.g., subtracted, from the received composite signal (samples) (Step 154), leaving a reduced interference signal for detection of the desired signal's data symbols (Step 156). Interference suppression according to exemplary successive cancellation methods detailed above are applicable to disparately modulated signals, wherein the interfering and desired signals have different modulation formats.

The present invention has, as noted, applicability to a wide range of wireless receiver types. Its inclusion in a mobile terminal intended for use in a wireless communication system may, however, be particularly advantageous. As used herein, the term “mobile terminal” may include a cellular radiotelephone with or without a multi-line display; a Personal Communications System (PCS) terminal that may combine a cellular radiotelephone with data processing, facsimile and data communications capabilities; a PDA that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver. Mobile terminals also may be referred to as “pervasive computing” devices.

FIG. 8 illustrates an exemplary mobile terminal 200, which comprises a receiver front-end 202, a transmitter front-end 204, an antenna assembly 206, a switch/duplexer 208, a baseband processor circuit 210 (including receiver circuit 12, receiver signal processor 30, a transmit processor 212, and additional processing logic 214), system processor 216, user interface 218 (which may include display screens, keypads, audio input and output transducers, etc.), one or more memory devices 220, and a frequency synthesizer 222.

Notably, by including one or more of the exemplary embodiments of receiver circuit 12, the baseband processing circuit 210 performs one or more embodiments of the interferer hypothesis and interference suppression discussed earlier herein. That is, mobile terminal 200 may operate in a wireless communication network wherein it receives desired and interfering signals, and it may hypothesize one or more interferers, test those hypothesizes by, for example, joint channel estimation, and then use the channel models obtained for the best hypothesized interferers to suppress interference in the desired signal. As noted, generating a whitening filter based on channel models for the best hypothesized interferers as obtained during joint synchronization represents an exemplary suppression method.

Baseband processor circuit 210 may comprise one or more processing circuits as needed or desired. As such, receiver circuit 12, with its hypothesis generator 14, joint processor 18, etc., may be implemented as a stand-alone circuit (using discrete or integrated processing circuits), or may be implemented as part of a larger processing circuit. For example, receiver circuit 12 may be implemented in hardware, software (or both) within a digital signal processor used by mobile terminal 200 as part of its baseband or other processing.

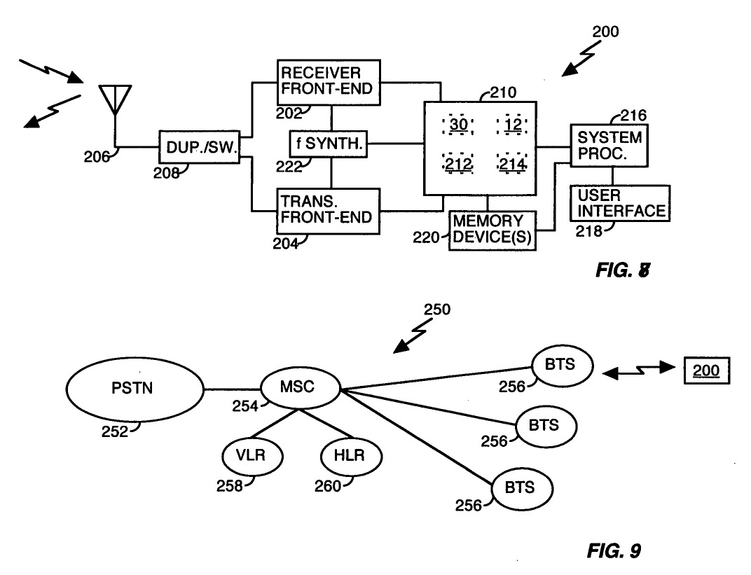

Receiver circuit 12 may yield operational benefits when applied to other communication network entities such as where it is used in network-based receivers. FIG. 9 depicts an exemplary wireless communication network 250, which may be, but is not limited to, a GSM or GSM/EDGE network. Network 250 communicatively couples mobile terminals 200 (which may implement the present invention as well) to one or more external networks, such as the Public Switched Telephone Network (PSTN) 252. In an exemplary embodiment, network 250 comprises one or more Mobile Switching Centers 254, one or more Base Transceiver States (BTSs) 256, a Visitor Location Register (VLR) 258, and a Home Location Register (HLR) 260. Those skilled in the art will appreciate that other network architectures may be used, and that network 250 may include more or different entities as needed or desired.

In any case, BTSs 256 include radio receivers for communicating with pluralities of supported mobile stations. As such, BTSs 256 might advantageously include one or more of the earlier illustrated receiver circuits 12 to provide hypothesis generation/testing and interference cancellation in network 250 according to one or more of the earlier described embodiments.

Generally, the present invention may be used in a wide range of wireless communication receiver types. In one or more exemplary embodiments, at least portions of receiver circuit 12 may be implemented as an Integrated Circuit (IC). Thus, some or all of receiver circuit 12 may be implemented as coded program instructions stored in a computer-readable medium (such as memory device(s) 220 which may comprise FLASH, EPROM, etc.) that instruct a processor to carry out the inventive interference hypothesis and suppression operations. Such a processor might be a Digital Signal Processor (DSP), a microprocessor or microcontroller, or might be a logic circuit (or circuits) implemented as part of an Application Specific Integrated Circuit (ASIC). Additionally, some or all of RAKE receiver 12 may be implemented as programmable or dedicated logic circuits within a Complex Programmable Logic Device (CPLD), Field Programmable Gate Array (FPGA), or other form of Integrated Circuit (IC). Of course, the foregoing embodiments are exemplary rather than exhaustive.

Additionally, those skilled in the art should recognize that, in general, the foregoing description and the accompanying illustrations represent exemplary embodiments of the present invention and should not be construed as limiting it. Indeed, the present invention is limited only by the following claims and the reasonable equivalents thereof.

1. An interference suppression method for use in a wireless communication receiver, the method comprising:
receiving one or more interfering signals along with receiving a desired signal;
generating one or more interference hypotheses for the interfering signals based on hypothesized combinations of known signal sequences and relative signal delays; and
testing the one or more interference hypotheses to identify one or more dominant interferers from among the interfering signals.

2. The method of claim 1, wherein generating one or more interference hypotheses for the interfering signals based on hypothesized combinations of known signal sequences and relative signal delays comprises generating hypothesized interferers based on known training sequences taken at one or more hypothesized delays.

3. The method of claim 2, further comprising receiving information from an associated communication network that identifies particular ones in a defined set of known training sequences that are being used in potentially interfering signals being transmitted by the network in or around a same area as the receiver, and limiting a training sequence search space associated with generation of the interference hypotheses to those particular known training sequences.

4. The method of claim 1, further comprising limiting a delay search space associated with generating the one or more interference hypotheses by assuming that all interfering signals lag the desired signal.

5. The method of claim 1, wherein receiving one or more interfering signals along with receiving a desired signal comprises receiving the interfering and desired signals on one or more receive antennas.

6. The method of claim 1, further comprising considering adjacent channel interference by hypothesizing one or more channel frequency offsets, such that at least one of the one or more interference hypotheses comprises a hypothesized combination of channel frequency offset, known signal sequence, and relative signal delay.

7. The method of claim 6, wherein testing the one or more interference hypotheses to identify one or more dominant interferers from among the interfering signals comprises performing joint channel estimations for the desired signal and the interference hypotheses, and further comprising applying a rotation factor as needed to account for hypothesized channel frequency offsets during joint channel estimations.

8. The method of claim 1, further comprising considering one or more different modulation formats by hypothesizing at least one modulation format different than a modulation format of the desired signal, such that at least one of the one or more interference hypotheses comprises a hypothesized combination of modulation format, known signal sequence, and relative signal delay.

9. The method of claim 8, wherein testing the one or more interference hypotheses to identify one or more dominant interferers from among the interfering signals comprises performing joint channel estimations for the desired signal and the interference hypotheses, and further comprising applying a rotation factor as needed to account for hypothesized modulation formats during joint channel estimations.

10. The method of claim 1, wherein testing the one or more interference hypotheses to identify one or more dominant interferers from among the interfering signals comprises jointly estimating channel models for the desired signal and the one or more hypothesized interferers and evaluating results of the joint estimations.

11. The method of claim 1, wherein testing the one or more interference hypotheses to identify one or more dominant interferers from among the interfering signals comprises performing joint synchronization and channel estimation for the desired signal and the one or more hypothesized interferers and evaluating results of the joint synchronization and channel estimation.

12. The method of claim 11, wherein performing joint synchronization and channel estimation for the desired signal and one or more hypothesized interferers comprises performing Joint Least Squares (JLS) estimations using the desired signal and the one or more hypothesized interferers.

13. The method of claim 12, further comprising pre-computing one or more Least Squares (LS) matrices for one or more combinations of the desired signal and the hypothesized interferers.

14. The method of claim 11, wherein performing joint synchronization and channel estimation for the desired signal and one or more hypothesized interferers comprises performing Maximum a Posteriori (MAP) estimations using the desired signal and the one or more hypothesized interferers.

15. The method of claim 1, wherein testing the one or more interference hypotheses to identify one or more dominant interferers from among the interfering signals comprises jointly estimating channel models for the desired signal and the one or more hypothesized interferers, and identifying the one or more dominant interferers based on determining which hypothesized interferers yield the best channel models.

16. The method of claim 15, further comprising generating a whitening filter based on the channel models obtained for the one or more dominant interferers.

17. The method of claim 16, further comprising using the whitening filter to cancel interference from the desired signal.

18. The method of claim 16, wherein the desired signal is a GMSK-modulated TDMA carrier, and further comprising performing interference rejection based on a spatial-temporal whitening filter.

19. The method of claim 16, wherein the desired signal is an 8PSK-modulated TDMA carrier, and further comprising de-rotating the received signal with respect to one or more GMSK-modulated interfering signals before using the whitening filter to cancel interference from the desired signal.

20. The method of claim 16, further comprising generating a whitening filter based on a residual signal obtained by subtracting a reconstructed version of the desired signal from the received signal.

21. The method of claim 16, further comprising generating a whitening filter based on reconstructed interfering signals.

22. The method of claim 1, wherein receiving one or more interfering signals along with receiving a desired signal comprises receiving desired and interfering signals in each of one or more communication timeslots.

23. The method of claim 22, wherein generating one or more interference hypotheses for the interfering signals based on hypothesized combinations of known signal sequences and relative signal delays comprises generating the one or more interference hypotheses in each communication timeslot.

24. The method of claim 23, wherein testing the one or more interference hypotheses to identify one or more dominant interferers from among the interfering signals comprises identifying the one or more dominant interferers in each communication timeslot, such that interference can be suppressed on a per timeslot basis.

25. An interference suppression method for use in a wireless communication receiver, the method comprising:
simultaneously receiving desired and interfering signals;
hypothesizing one or more interferers based on known training sequences; and
determining which hypothesized interferers best correspond to actual interference.

26. The method of claim 25, further comprising suppressing interference based on the one or more hypothesized interferers determined to best correspond to the actual interference.

27. The method of claim 25, wherein simultaneously receiving desired and interfering signals comprises receiving a training sequence of the desired signal and receiving at least partially overlapping training sequences of one or more interfering signals.

28. The method of claim 27, wherein hypothesizing one or more interferers based on known training sequences comprises assuming that one or more particular training sequences were received at one or more relative signal delays in conjunction with receiving the training sequence of the desired signal.

29. The method of claim 28, wherein determining which hypothesized interferers best correspond to actual interference comprises identifying which combination or combinations of assumed training sequences and relative signal delays yield a lowest channel model estimation error for the desired signal.

30. The method of claim 25, further comprising hypothesizing one or more interferers further based on assumed adjacent channel frequency offsets.

31. The method of claim 25, further comprising hypothesizing one or more interferers further based on one or more assumed modulation formats different from a modulation format of the desired signal.

32. The method of claim 25, further comprising reducing a search space for hypothesizing the one or more interferers by assuming that all interfering signals received lag the desired signal.

33. The method of claim 25, further comprising reducing a search space for hypothesizing the one or more interferers by assuming hypothesizing interferers based on a reduced number of possible training sequences.

34. The method of claim 33, further comprising determining the reduced number of possible training sequences based on information received from a supporting wireless communication network.

35. The method of claim 34, wherein simultaneously receiving desired and interfering signals comprises receiving desired and interfering signals in each of one or more communication timeslots, and wherein hypothesizing one or more interferers based on known training sequences comprises hypothesizing one or more interferers in each communication timeslot.

36. The method of claim 35, wherein determining which hypothesized interferers best correspond to actual interference comprises determining the best hypothesized interferer or interferers in each communication timeslot.

37. A receiver circuit for use in a wireless communication receiver, the receiver circuit comprising processing logic configured to:
generate one or more interference hypotheses for interfering signals received along with a desired signal based on combinations of known signal sequences and relative signal delays; and
test the one or more interference hypotheses to identify one or more dominant interfering signals.

38. The receiver circuit of claim 37, wherein the receiver circuit generates one or more interference hypotheses for the interfering signals based on combinations of known signal sequences and relative signal delays by generating hypothesized interferers based on known training sequences taken at one or more hypothesized delays.

39. The receiver circuit of claim 38, wherein the receiver circuit is configured to receive information from a supporting communication network that identifies particular ones in a defined set of known training sequences, and limiting a training sequence search space associated with generation of the interference hypotheses to those particular known training sequences.

40. The receiver circuit of claim 37, wherein the receiver circuit is configured to limit a delay search space associated with generating the one or more interference hypotheses by assuming that all interfering signals lag the desired signal.

41. The receiver circuit of claim 37, wherein the receiver circuit is configured to consider adjacent channel interference by hypothesizing one or more channel frequency offsets, such that at least one of the one or more interference hypotheses comprises a hypothesized combination of channel frequency offset, known signal sequence, and relative signal delay.

42. The receiver circuit of claim 41, wherein the receiver circuit is configured to test the one or more interference hypotheses to identify one or more dominant interferers from among the interfering signals by performing joint channel estimations for the desired signal and the interference hypotheses, and further comprising applying a rotation factor as needed to account for hypothesized channel frequency offsets during joint channel estimations.

43. The receiver circuit of claim 37, wherein the receiver circuit is configured to consider one or more different modulation formats by hypothesizing at least one modulation format different than a modulation format of the desired signal, such that at least one of the one or more interference hypotheses comprises a hypothesized combination of modulation format, known signal sequence, and relative signal delay.

44. The receiver circuit of claim 43, wherein the receiver circuit is configured to test the one or more interference hypotheses to identify one or more dominant interferers from among the interfering signals by performing joint channel estimations for the desired signal and the interference hypotheses, and further by applying a rotation factor as needed to account for hypothesized modulation formats during joint channel estimations.

45. The receiver circuit of claim 37, wherein the receiver circuit is configured to test the one or more interference hypotheses to identify one or more dominant interferers from among the interfering signals by jointly estimating channel models for the desired signal and the one or more hypothesized interferers and evaluating results of the joint estimations.

46. The receiver circuit of claim 37, wherein the receiver circuit is configured to test the one or more interference hypotheses to identify one or more dominant interferers from among the interfering signals by performing joint synchronization and channel estimation for the desired signal and the one or more hypothesized interferers and evaluating results of the joint synchronization and channel estimation.

47. The receiver circuit of claim 46, wherein the receiver circuit is configured to perform joint synchronization and channel estimation for the desired signal and one or more hypothesized interferers by performing Joint Least Squares (JLS) estimations using the desired signal and the one or more hypothesized interferers.

48. The receiver circuit of claim 47, wherein the receiver circuit is configured to pre-compute one or more Least Squares (LS) matrices for one or more combinations of the desired signal and the hypothesized interferers.

49. The receiver circuit of claim 46, wherein the receiver circuit is configured to perform joint synchronization and channel estimation for the desired signal and one or more hypothesized interferers comprises by Maximum a Posteriori (MAP) estimations using the desired signal and the one or more hypothesized interferers.

50. The receiver circuit of claim 37, wherein the receiver circuit is configured to test the one or more interference hypotheses to identify one or more dominant interferers from among the interfering signals by jointly estimating channel models for the desired signal and the one or more hypothesized interferers, and identifying the one or more dominant interferers based on determining which hypothesized interferers yield the best channel models.

51. The receiver circuit of claim 50, wherein the receiver circuit is configured to generate a whitening filter based on the channel models obtained for the one or more dominant interferers.

52. The receiver circuit of claim 51, wherein the receiver circuit is configured to use the whitening filter to cancel interference from the desired signal.

53. The receiver circuit of claim 51, wherein the desired signal is a GMSK-modulated TDMA carrier, and wherein the receiver circuit is configured to perform Single Antenna Interference Rejection (SAIR) based on the whitening filter.

54. The receiver circuit of claim 51, wherein the desired signal is an 8PSK-modulated TDMA carrier, and wherein the receiver circuit is configured to de-rotate the desired signal with respect to one or more GMSK-modulated interfering signals before using the whitening filter to cancel interference from the desired signal.

55. The receiver circuit of claim 37, wherein the receiver circuit comprises an Application Specific Integrated Circuit (ASIC).

56. The receiver circuit of claim 37, wherein the receiver circuit is configured to generate the one or more interference hypotheses in each of one or more communication timeslots.

57. The receiver circuit of claim 56, wherein the receiver circuit is configured to test the one or more interference hypotheses in each communication timeslot, such that the one or more dominant interfering signals are identified per communication timeslot.

58. A receiver circuit for use in a wireless communication receiver that receives one or more interfering signals along with receiving a desired signal, the receiver circuit comprising:
a hypothesis generator circuit to generate one or more hypothesized interferers based on known training sequences; and
an valuation circuit to determine which hypothesized interferers best correspond to actual interference.

59. The receiver circuit of claim 58, further comprising an interference suppression circuit to suppress interference based on the one or more hypothesized interferers determined to best correspond to the actual interference.

60. The receiver circuit of claim 58, wherein the receiver receives a training sequence of the desired signal and at least partially overlapping training sequences of one or more interfering signals, and wherein the hypothesis generator circuit is configured to generate the one or more hypothesized interferers by assuming that one or more particular training sequences were received at one or more relative signal delays in conjunction with receiving the training sequence of the desired signal.

61. The receiver circuit of claim 60, wherein the evaluation circuit is configured to determine which hypothesized interferers best correspond to actual interference by identifying which combination or combinations of assumed training sequences and relative signal delays yield a lowest channel model estimation error for the desired signal.

62. The receiver circuit of claim 60, wherein the evaluation circuit comprises a joint synchronization and channel estimation circuit that determines which hypothesized interferer yield a lowest channel model estimation error for the desired signal.

63. The receiver circuit of claim 58, wherein the receiver circuit is configured to generate the one or more hypothesized interferers in each of one or more communication timeslots.

64. The receiver circuit of claim 63, wherein the receiver circuit is configured to determine which hypothesized interferers best corresponds to actual interference in each communication timeslot.

65. A computer readable medium storing a computer program for controlling a receiver circuit used in a wireless communication receiver that simultaneously receives desired and interfering signals, the computer program comprising:
program instructions to generate one or more hypothesized interferers based on known training sequences; and
program instructions to determine which hypothesized interferers best correspond to actual interference.

66. The computer readable medium of claim 65, wherein the computer program further comprises program instructions to suppress interference based on the one or more hypothesized interferers determined to best correspond to the actual interference.

67. The computer readable medium of claim 65, wherein the receiver receives a training sequence of the desired signal and at least partially overlapping training sequences of one or more interfering signals, and wherein the program instructions to generate the one or more hypothesized interferers comprise program instructions to assume that one or more particular training sequences were received at one or more relative signal delays in conjunction with receiving the training sequence of the desired signal.

68. The computer readable medium of claim 67, wherein the program instructions to determine which hypothesized interferers best correspond to actual interference comprise program instructions to identify which combination or combinations of assumed training sequences and relative signal delays yield a lowest channel model estimation error for the desired signal.

69. The computer readable medium of claim 68, wherein the program instructions to identify which combination or combinations of assumed training sequences and relative signal delays yield a lowest channel model estimation error for the desired signal comprises program instructions to perform joint estimation of channel models for the desired signal and the one or more hypothesized interferers, and to evaluate resulting channel model estimation errors for the desired signal.

70. The computer readable medium of claim 65, wherein the program instructions to generate one or more hypothesized interferers based on known training sequences comprise program instructions to generate the one or more hypothesized interferers in each of one or more communication timeslots.

71. The computer readable medium of claim 70, wherein the program instructions to determine which hypothesized interferers best correspond to actual interference comprise program instructions to determine which hypothesized interferers best correspond to actual interference in each communication timeslot.

72. A method of suppressing interference in a wireless communication receiver, the method comprising:
buffering a composite received signal comprising combined desired and interfering signals;
generating an estimated interfering signal by suppressing the desired signal in the composite received signal; and
recovering the desired signal from the composite received signal by canceling the estimated interfering signal from the composite received signal.

73. The method of claim 72, wherein buffering a composite received signal comprises generating and storing baseband samples of an antenna-received signal.

74. The method of claim 72, wherein generating an estimated interfering signal by suppressing the desired signal in the composite received signal comprises:
generating a whitening filter based on known data in the desired signal and on a channel model for the desired signal; and
applying the whitening filter to a copy of the composite received signal.

75. The method of claim 74, wherein generating a whitening filter based on known data in the desired signal and on a channel model for the desired signal comprises:
reconstructing the desired signal over a desired signal training period using a known training sequence and desired signal channel estimates; and
estimating the whitening filter based on the reconstructed desired signal.

76. The method of claim 72, wherein generating an estimated interfering signal by suppressing the desired signal in the composite received signal comprises:
obtaining a filtered signal by applying a whitening filter to the composite received signal, wherein the whitening filter is configured to suppress the desired signal;
detecting interfering data symbols in the filtered signal.

77. The method of claim 76, wherein recovering the desired signal from the composite received signal by canceling the estimated interfering signal from the composite received signal comprises reconstructing the interfering signal using its channel model and the detected data symbols and subtracting the reconstructed interfering signal from the composite received signal.

78. A method of suppressing interference in a wireless communication receiver, the method comprising:
generating received signal samples of a received signal that comprises a combination of desired and interfering signals;
calculating a whitening filter to suppress the desired signal;
generating filtered samples by applying the whitening filter to the received signal samples;
recovering interfering signal data symbols from filtered samples; and
recovering desired signal data symbols by canceling a reconstructed version of the interfering signal from the received signal samples.

79. A mobile terminal for use in a wireless communication network comprising:
a transmitter to transmit signals to the network; and
a receiver to receive signals transmitted by the network;
said receiver comprising a receiver circuit configured to:
generate one or more interference hypotheses for interfering signals received along with a desired signal based on combinations of known signal sequences and relative signal delays; and
test the one or more interference hypotheses to identify one or more dominant interfering signals.

80. The mobile terminal of claim 79, wherein the receiver circuit generates one or more interference hypotheses for the interfering signals received based on combinations of known signal sequences and relative signal delays by generating hypothesized interferers based on known training sequences taken at one or more hypothesized delays.

81. The mobile terminal of claim 80, wherein the receiver circuit is configured to receive information from a supporting communication network that identifies particular ones in a defined set of known training sequences, and limiting a training sequence search space associated with generation of the interference hypotheses to those particular known training sequences.

82. The mobile terminal of claim 79, wherein the receiver circuit is configured to limit a delay search space associated with generating the one or more interference hypotheses by assuming that all interfering signals lag the desired signal.

83. The mobile terminal of claim 79, wherein the receiver circuit is configured to consider adjacent channel interference by hypothesizing one or more channel frequency offsets, such that at least one of the one or more interference hypotheses comprises a hypothesized combination of channel frequency offset, known signal sequence, and relative signal delay.

84. The mobile terminal of claim 83, wherein the receiver circuit is configured to test the one or more interference hypotheses to identify one or more dominant interferers from among the interfering signals by performing joint channel estimations for the desired signal and the interference hypotheses, and further comprising applying a rotation factor as needed to account for hypothesized channel frequency offsets during joint channel estimations.

85. The mobile terminal of claim 79, wherein the receiver circuit is configured to consider one or more different modulation formats by hypothesizing at least one modulation format different than a modulation format of the desired signal, such that at least one of the one or more interference hypotheses comprises a hypothesized combination of modulation format, known signal sequence, and relative signal delay.

86. The mobile terminal of claim 85, wherein the receiver circuit is configured to test the one or more interference hypotheses to identify one or more dominant interferers from among the interfering signals by performing joint channel estimations for the desired signal and the interference hypotheses, and further by applying a rotation factor as needed to account for hypothesized modulation formats during joint channel estimations.

87. The mobile terminal of claim 79, wherein the receiver circuit is configured to test the one or more interference hypotheses to identify one or more dominant interferers from among the interfering signals by jointly estimating channel models for the desired signal and the one or more hypothesized interferers and evaluating results of the joint estimations.

88. The mobile terminal of claim 79, wherein the receiver circuit is configured to test the one or more interference hypotheses to identify one or more dominant interferers from among the interfering signals by performing joint synchronization and channel estimation for the desired signal and the one or more hypothesized interferers and evaluating results of the joint synchronization and channel estimation.

89. The mobile terminal of claim 88, wherein the receiver circuit is configured to perform joint synchronization and channel estimation for the desired signal and one or more hypothesized interferers by performing Joint Least Squares (JLS) estimations using the desired signal and the one or more hypothesized interferers.

90. The mobile terminal of claim 89, wherein the receiver circuit is configured to pre-compute one or more Least Squares (LS) matrices for one or more combinations of the desired signal and the hypothesized interferers.

91. The mobile terminal of claim 88, wherein the receiver circuit is configured to perform joint synchronization and channel estimation for the desired signal and one or more hypothesized interferers comprises by Maximum a Posteriori (MAP) estimations using the desired signal and the one or more hypothesized interferers.

92. The mobile terminal of claim 79, wherein the receiver circuit is configured to test the one or more interference hypotheses to identify one or more dominant interferers from among the interfering signals by jointly estimating channel models for the desired signal and the one or more hypothesized interferers, and identifying the one or more dominant interferers based on determining which hypothesized interferers yield the best channel models.

93. The mobile terminal of claim 92, wherein the receiver circuit is configured to generate a whitening filter based on the channel models obtained for the one or more dominant interferers.

94. The mobile terminal of claim 93, wherein the receiver circuit is configured to use the whitening filter to cancel interference from the desired signal.

95. The mobile terminal of claim 93, wherein the desired signal is a GMSK-modulated TDMA carrier, and wherein the receiver circuit is configured to perform Single Antenna Interference Rejection (SAIR) based on the whitening filter.

96. The mobile terminal of claim 93, wherein the desired signal is an 8PSK-modulated TDMA carrier, and wherein the receiver circuit is configured to de-rotate the desired signal with respect to one or more GMSK-modulated interfering signals before using the whitening filter to cancel interference from the desired signal.

97. The mobile terminal of claim 79, wherein the receiver circuit is configured to generate the one or more interference hypotheses in each of one or more communication timeslots assigned to the receiver, and to test the one or more interference hypotheses in each communication timeslot, such that the one or more dominant interfering signals are identified in each communication timeslot.

98. A base station for use in a wireless communication network comprising:
a transmitter to transmit signals to mobile terminals; and
a receiver to receive signals transmitted by the mobile terminals;
said receiver comprising a receiver circuit configured to:
generate one or more interference hypotheses for interfering signals received along with a desired signal based on combinations of known signal sequences and relative signal delays; and
test the one or more interference hypotheses to identify one or more dominant interfering signals.

99. The base station of claim 98, wherein the receiver circuit generates one or more interference hypotheses for the interfering signals received based on combinations of known signal sequences and relative signal delays by generating hypothesized interferers based on known training sequences taken at one or more hypothesized delays.
